(19) United States
(12) Patent Application Publication
(10) Pub. No.: US 2007/0237442 A1
(43) Pub. Date: Oct. 11, 2007

(54) Transparent conducting components and related electro-optic modulator devices

(76) Inventors: Tobin J. Marks, Evanston, IL (US); Seng-Tiong Ho, Wheeling, IL (US); Jing Ma, Buffalo Grove, IL (US); Guoyang Xu, Evanston, IL (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/225,553

(22) Filed: Sep. 13, 2005

Related U.S. Application Data
(60) Provisional application No. 60/609,433, filed on Sep. 13, 2004.
(60) Provisional application No. 60/704,644, filed on Aug. 2, 2005.

(51) Int. Cl. G02F 1/035

(52) U.S. Cl. 385/2

(57) ABSTRACT

New electro-optic (EO) phase modulator devices and geometries, as can be constructed using a transparent conductive component.

This application claims priority benefit from prior provisional application Ser. No. 60/609,433, filed Sep. 13, 2004 and prior provisional application Ser. No. 60/704,644, filed Aug. 2, 2005, each of which is incorporated herein by reference in its entirety.

The United States government has certain rights to Grant No. DAAD-19-00-1-0368 from DARPA and Grant No. DMR-00769097 from the National Science Foundation to Northwestern University.

### FIELD OF THE INVENTION

This invention relates to electro-optic modulators, modulator geometries, and the materials and methods used to fabricate such modulators.

### BACKGROUND OF INVENTION

Over the past thirty years, significant time and effort has been dedicated to the study of various materials such as, LiNbO₃, III-V semiconductors, and organic polymers, to determine their respective characteristics for the fabrication and performance as electro-optic (EO) devices (e.g., modulators, waveguides, switches, emitters, detectors, and the like). For example, organic modulators have been demonstrated at operating frequencies as high as 113 GHz and a.V_{π} of approximately 0.8V. However, for applications to Radio-Frequency Photonics (RF Photonics) in which a high-frequency electrical signal is transmitted not via a metallic transmission line but via an optical fiber, a much lower modulation voltage of around 0.5V or smaller is required. It is well known that the power consumption of an electro-optic modulator is proportional to the square of the modulation voltage. Hence, other than RF Photonics applications, it is generally desirable to lower the switching or modulating voltage of an electro-optic modulators for the purpose of saving driving power. In addition, lowering the driving power also leads to lower heat dissipation, which will help in achieving higher-density device integration.

For a given electro-optically active material, the prior high-speed electro-optic device structures are limited in their ability to provide low voltage operation. Present high-speed electro-optic devices utilize metals as the voltage-conducting electrodes. Metals, however, are very absorptive with respect to an optical beam propagating within the electro-optically active material. This limits how close the metal electrodes can be, which subsequently limits the strength of the electric field achievable at the electro-optically active material and, hence, the modulator voltage. The present electro-optic modulator structures are thus incapable of achieving much lower modulation voltages without incurring higher optical losses. Such considerations make it difficult to achieve low modulation voltage, high integration density, or smaller device sizes, and consequently limit applications of such devices

### SUMMARY OF THE INVENTION

In light of the foregoing, it is an object of the present invention to provide electro-optic devices, including, but without limitation, related modulator and waveguide devices and/or methods for their production and/or assembly, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of this invention to provide an electro-optic modulator device, in comparison to the prior art, with lower switching or modulation voltages achievable without incurring higher optical losses. Alternatively, it is a related object to provide such devices with switching or modulation voltages comparable to the prior art, but achievable with smaller device sizes.

It can be another object of the present invention, in conjunction with one of the preceding objectives to obtain or maintain high modulation frequency capability.

It can be another object of the present invention, in conjunction with one or more of the preceding objectives, to provide, in comparison with the prior art, a high-frequency modulator with lower voltage, lower driving power and/or higher integration density.

As provided above and elsewhere herein, in one aspect of the present invention, an objective of this invention is to provide an electro-optic device structure that reduces the driving voltage for a given electro-optic modulator device length and yet still maintains a reasonably high frequency of operation. Accordingly, using various embodiments of this invention, this and other objectives can be achieved by electro-optic modulator structures comprising exemplary transparent conducting (TC) components connected or coupled to electrode structures about electro-optic (EO) materials—such materials including but not limited to electrically poled polymers of the prior art, more recently developed self-assembled superlattice (SAS) organic materials, inorganic crystal electro-optic materials known and available in the art (e.g. Lithium Niobate (LiNbO₃) or Barium Titanate (BaTiO₃)), and III-V semiconductors (e.g., Gallium Arsenide (GaAs), Aluminum Arsenide (AlAs), Indium Phosphide (InP), Indium Ganium Arsenide Phosphide (InGaAsP)). Representative organic and/or superlattice materials and related device structures are described in U.S. Pat. Nos. 6,549,685; 6,033,774 and 5,156,198 each of which is incorporated herein by reference in its entirety.

In another aspect of the present invention, in several embodiments, the conductive components can be made of materials that are optically transparent and yet electrically conductive—referred to as transparent conductors (TC). Such transparent conducting components can impose a higher electric field across the EO channel waveguide, resulting in lower modulator switching voltage.

In yet another aspect of the present invention, such a device can comprise a TC on both the top and bottom or about the cladding regions of the EO material and be referred to as a vertical conduction structure, with the vertical direction perpendicular to the substrate on which the EO device layered structures are laid.

In yet another aspect of the present invention, such a device can comprise a TC on two sides of the cladding regions of the EO material and be referred to as a side-conduction structure.

In yet another aspect of the present invention, a TC component can comprise one or more of a class of materials known as transparent conducting oxides (TCO).

In yet another aspect of the present invention, two TC electrodes of a modulator device can be further electrically conducted to two metal electrodes that form RF traveling-wave electrodes of the sort useful for achieving higher frequency of operation.

In yet another aspect of the present invention, in the case of an organic electro-optic modulator, modulators can be fabricated using low processing temperatures in order not to adversely affect active electro-optic polymers. TC/TCO components can be deposited at low temperature on the electro-optic polymers or other EO materials using various methods, including a sputtering system such as Ion Assisted Deposition (IAD) system. A polymer layer can then be grown via spin coating on top of or adjacent a first TC/TCO component or via self-assembly method. A second TC/TCO component can then be deposited on top of or adjacent the electro-optic polymers. Using a polymer with reasonably high EO coefficient together with transparent conductive structures, optical intensity or phase modulators with a very high modulation speed (e.g., 40˜100 GHz) and very low switching voltages (e.g., 0.1˜0.5V) can be realized. In the case of poled polymer modulators, a TC component of this invention can also reduce the electrical poling voltage required to pole the EO polymer.

As demonstrated below, using transparent conductor structures of this invention can result in modulator switching voltages ranging from about 5 to about 10 times lower than that of conventional structure due to a corresponding 5-10× smaller effective spacing between the two electrodes. In the case of an organic electro-optic modulator, it can also reduce the electrical poling voltage by about 5-10× when TCs are used as electrodes to pole an EO polymer.

Without limitation, two general modulator embodiments are illustrated below: a vertical conduction structure and a side-conduction structure. Both can comprise TC/TCO materials to achieve low switching voltages and yet maintain high modulation frequency. A vertical conducting design or structure can be conducive for the case where a TC material has a refractive index lower than that of the waveguide core. A side-conduction design or structure can be conducive where a TC material has a refractive index equal to or higher than that of the waveguide core. This side conduction geometry can further provide the advantage of allowing a TC material to have higher material loss coefficient than with a vertical conduction geometry. In yet another advantage of the side conduction structure, it can be used to provide either vertically-oriented electric field or horizontally-oriented electric field. As would be understood in the art, horizontal electric field can be often a preferred embodiment for certain inorganic-crystal based electro-optic materials.

Accordingly, this invention can meet one or more of the objectives provided or inferred from the preceding, and can be directed to optical intensity/phase modulation and, more specifically, to the design of modulator device structures that can (1) reduce the driving voltage of a polymer EO modulator, (2) without increasing device length, while (3) significantly lowering high modulation frequency.

Other objects, features, benefits and advantages of the present invention will be apparent from this summary and the following descriptions of certain embodiments, and will be readily apparent to those skilled in the art having a knowledge of various electro-optic devices and assembly/production techniques. Such objects, features, benefits and advantages will be apparent from the above as taken into conjunction with the accompanying examples, data, figures and all reasonable inferences to be drawn therefrom, alone or with consideration of the references incorporated herein.

The invention accordingly comprises the features of construction, combination of elements, and arrangement of components exemplified herein, as would be understood by those skilled in the art made aware of this invention.

### BRIEF DESCRIPTION OF THE DRAWINGS

In the drawing figures, which are not to scale, and which are merely illustrative, and wherein like reference numerals depict like elements throughout the several views:

FIG. 1 is a schematic diagram illustrating a typical structure of conventional organic EO modulator of the prior art:

σ₁, αᵢ, W₁, T₁ are the conductivity, absorption coefficient, width and thickness of layer metal contact 1; n₂, ∈₂, T₂ are the refractive index, dielectric constant, and thickness of layer cladding 1; n₃, ∈₃, T₃, r₃₃ are the refractive index, dielectric constant, thickness and EO coefficient of layer EO material; n₄, ∈₄, T₄ are the refractive index, dielectric constant, and thickness of layer cladding 2; σ₅, σ₅, T₅ are the conductivity, absorption coefficient, and thickness of layer metal contact 2; and n₆, ∈₆, T₆ are the refractive index, dielectric constant, and thickness of layer substrate.

FIG. 2 is a schematic diagram of an EO modulator structure using a TC material as cladding, in accordance with this invention:

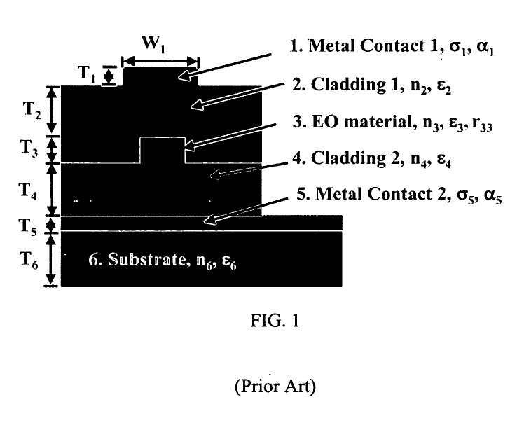

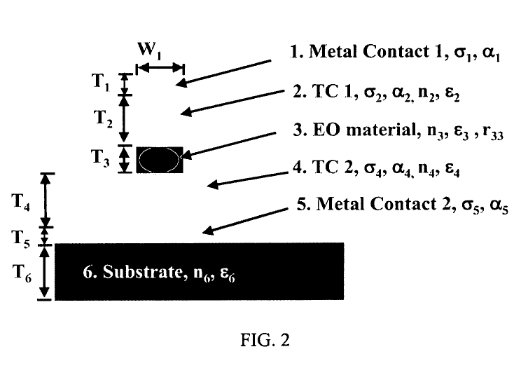

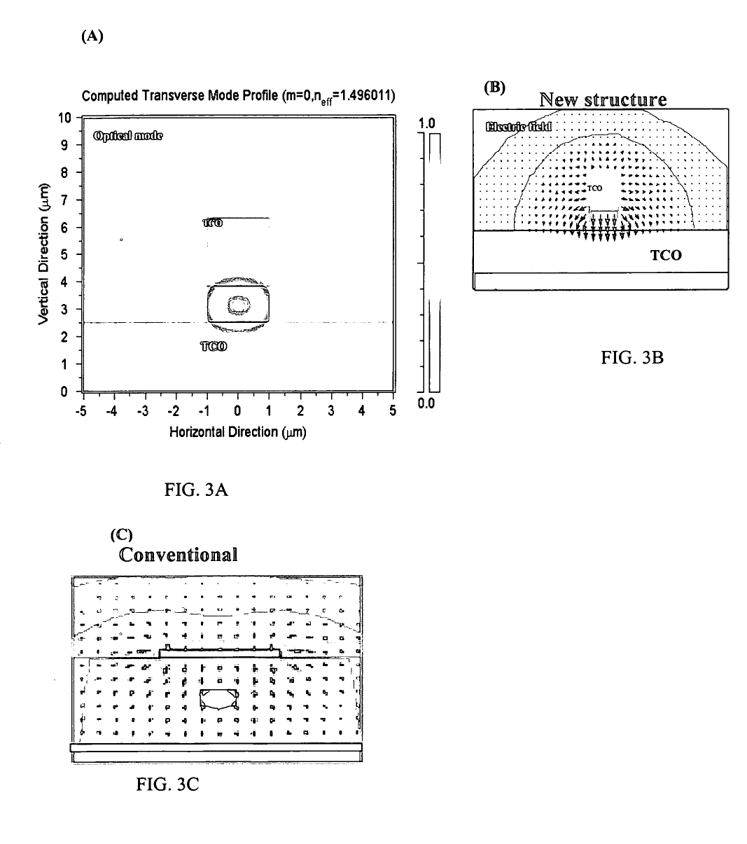

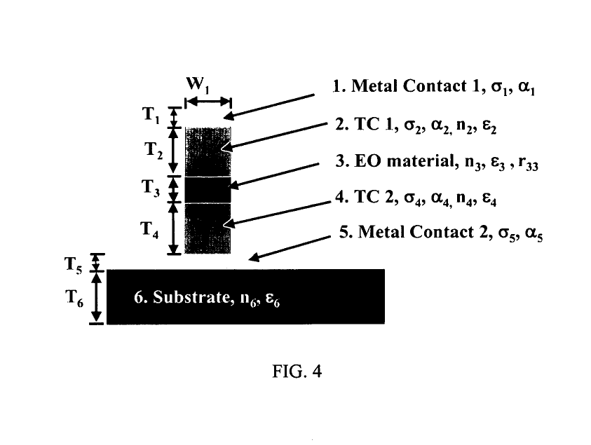

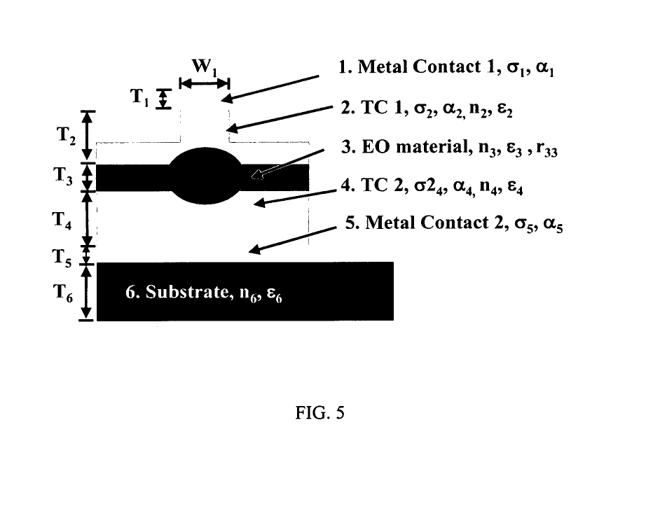

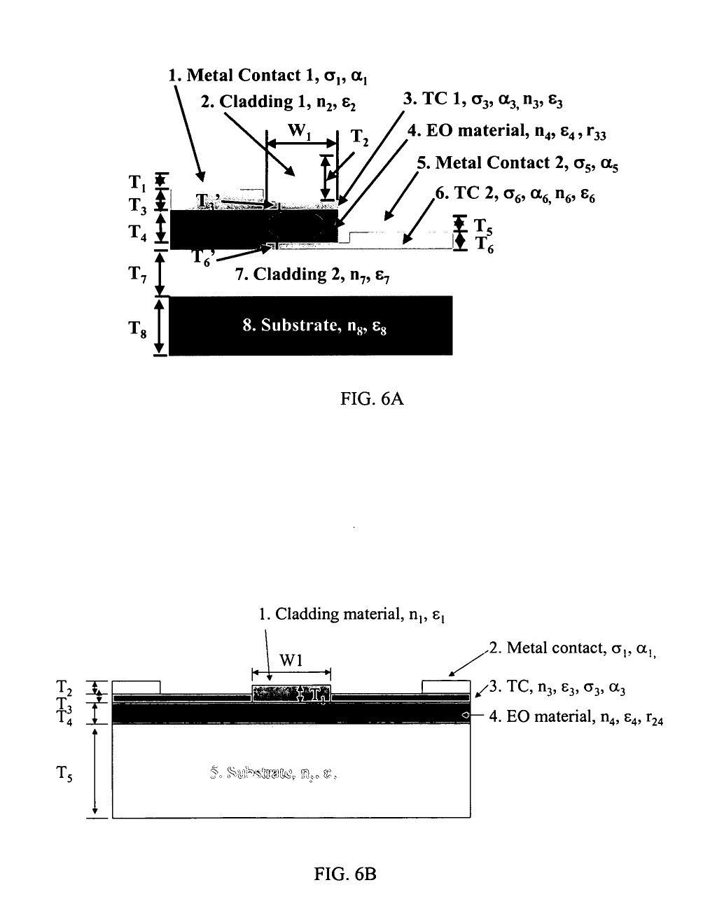

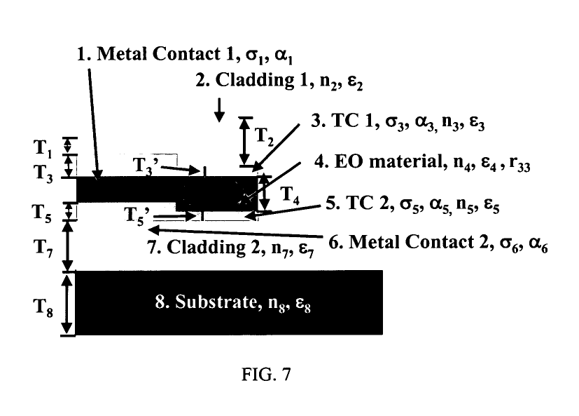

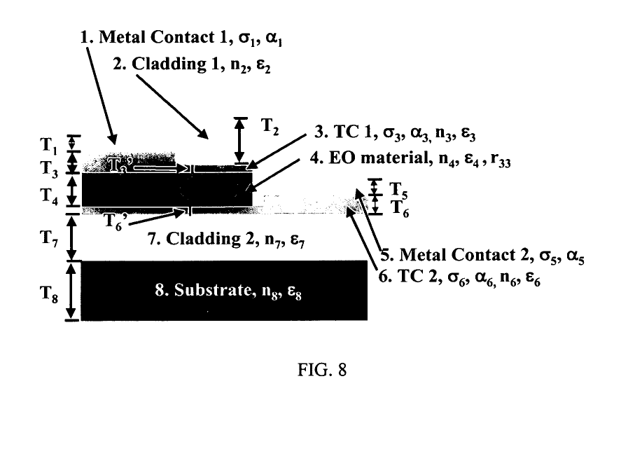

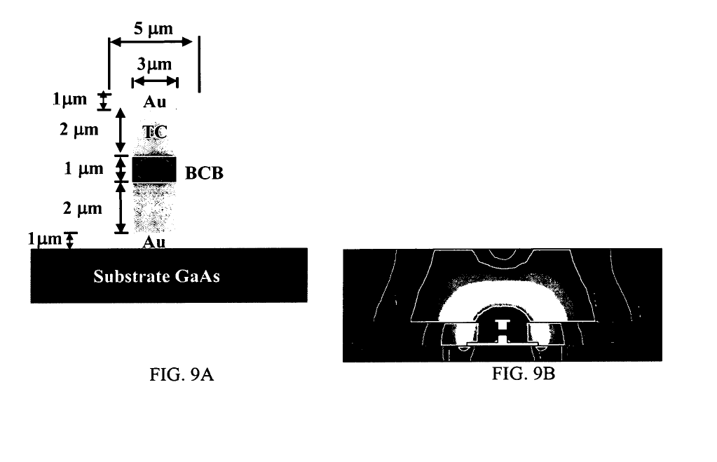

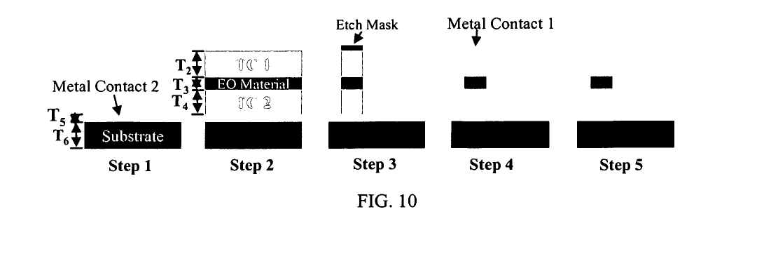

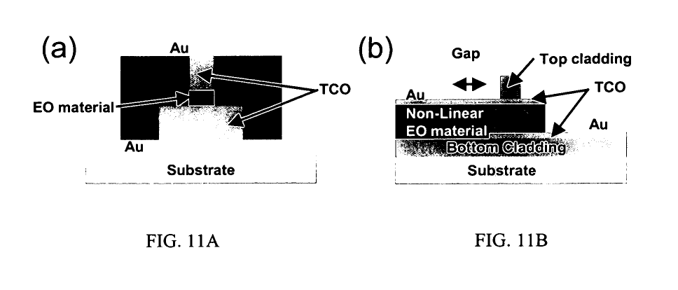

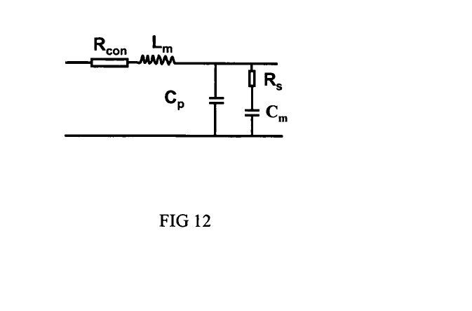

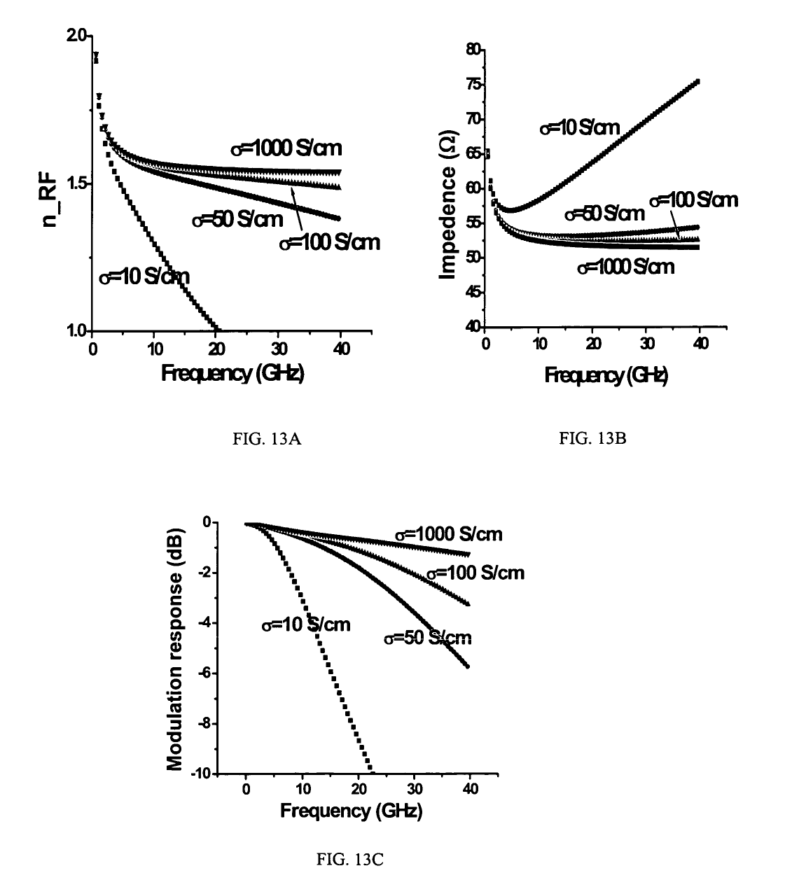

This design can have ˜5-10× lower switching voltage than the conventional design shown in FIG. 1. σ₁, α₁, W₁, T₁ are the conductivity, absorption coefficient, width and thickness of metal contact 1; σ₂, α₂, n₂, ∈₂, T₂ are the conductivity, absorption coefficient, refractive index, dielectric constant, and thickness of TC 1; n₃, ∈₃, T₃, r₃₃ are the refractive index, dielectric constant, thickness and EO coefficient of EO material; σ₄, σ₄, n₄, ∈₄, T₄ are the conductivity, absorption coefficient, refractive index, dielectric constant, and thickness of TC 2; σ₅, ∈₆, T₅ are the conductivity, absorption coefficient, and thickness of metal contact 2; and n₆, ∈₆, T₆ are the refractive index, dielectric constant, and thickness of substrate.

FIGS. 3A-C show: (A) optical mode of vertical-conduction modulator structures; (B) strong electric field of vertical-conduction modulator structures; and (C) conventional structure with much weaker electric field.

FIG. 4 is a schematic diagram of an EO modulator structure using vertical conduction, with etching to the bottom metal, in accordance with this invention:

σ₁, α₁, W₁, T₁ are the conductivity, absorption coefficient, width and thickness of metal contact 1; σ₂, α₂, n₂, ∈₂, T₂ are the conductivity, absorption coefficient, refractive index, dielectric constant, and thickness of TCO 1; n₃, ∈₃, T₃, r₃₃ are the refractive index, dielectric constant, thickness and EO coefficient of EO material; σ₄, α₄, n₄, ∈₄, T₄ are the conductivity, absorption coefficient, refractive index, dielectric constant, and thickness of TCO 2; σ₅, α₅, T₅ are the conductivity, absorption coefficient, and thickness of metal contact 2; and n₆, ∈₆, T₆ are the refractive index, dielectric constant, and thickness of substrate.

FIG. 5 is a schematic diagram of an EO modulator structure using vertical conduction, with partial etching to top TCO, in accordance with this invention:

σ₁, α₁, W₁, T₁ are the conductivity, absorption coefficient, width and thickness of metal contact 1; σ₂, α₂, n₂, ∈₂, T₂ are the conductivity, absorption coefficient, refractive index, dielectric constant, and thickness of TCO 1; n₃, ∈₃, T₃, r₃₃ are the refractive index, dielectric constant, thickness and EO coefficient of EO material; σ₄, α₄, n₄, ∈₄, T₄ are the conductivity, absorption coefficient, refractive index, dielectric constant, and thickness of TCO 2; σ₅, α₅, T₅ are the conductivity, absorption coefficient, and thickness of metal contact 2; and n₆, ∈₆, T₆ are the refractive index, dielectric constant, and thickness of substrate.

FIG. 6A is a schematic diagram of an EO modulator structure using a side-conduction design with a 1^{st}/top electrode on the left and a 2^{nd}/bottom electrode on the right, arranged in a geometry as to generate a vertical field at the EO material, in accordance with this invention:

σ₁, α₁, W₁, T₁ are the conductivity, absorption coefficient, width and thickness of metal contact 1; n₂, ∈₂, T₂ are the conductivity, absorption coefficient, refractive index, dielectric constant, and thickness of Cladding 1; σ₃, α₃, n₃, ∈₃, T₃ are the conductivity, absorption coefficient, refractive index, dielectric constant, and thickness of TCO 1; n₃, ∈₃, T₃, r₃₃ are the refractive index, dielectric constant, thickness and EO coefficient of EO material; σ₅, α₅, T₅ are the conductivity, absorption coefficient, and thickness of metal contact 2; σ₆, α₆, n₆, ∈₆, T₆ are the conductivity, absorption coefficient, refractive index, dielectric constant, and thickness of TCO 2; n₇, ∈₇, T₇ are the conductivity, absorption coefficient, refractive index, dielectric constant, and thickness of Cladding 2; n₈, ∈₈, T₈ are the refractive index, dielectric constant, and thickness of substrate.

FIG. 6B is a schematic diagram of an EO modulator structure using a side-conduction design with a 1^{st}/top electrode on the left and a 2^{nd}/bottom electrode on the right, arranged in a geometry as to generate a horizontal field at the EO material in accordance with this invention:

σ₁, α₃, W₁, T₁ are the conductivity, absorption coefficient, width and thickness of metal contact 1; n₂, ∈₂, T₂ are the conductivity, absorption coefficient, refractive index, dielectric constant, and thickness of Cladding 1; σ₃, α₃, n₃, ∈₃, T₃ are the conductivity, absorption coefficient, refractive index, dielectric constant, and thickness of TCO 1; n₃, ∈₃, T₃, r₃₃ are the refractive index, dielectric constant, thickness and EO coefficient of EO material; σ₅, α₅, T₅ are the conductivity, absorption coefficient, and thickness of metal contact 2; σ₆, α₆, n₆, ∈₆, T₆ are the conductivity, absorption coefficient, refractive index, dielectric constant, and thickness of TCO 2; n₇, ∈₇, T₇ are the conductivity, absorption coefficient, refractive index, dielectric constant, and thickness of Cladding 2; n₈, ∈₈, T₈ are the refractive index, dielectric constant, and thickness of substrate.

FIG. 7 is a schematic diagram of an EO modulator structure using a side-conduction design with a 1^{st}/top electrode on the left and a 2^{nd}/bottom electrode covering the bottom, in accordance with this invention:

σ₁, α₁, W₁, T₁ are the conductivity, absorption coefficient, width and thickness of metal contact 1; n₂, ∈₂, T₂ are the conductivity, absorption coefficient, refractive index, dielectric constant, and thickness of Cladding 1; σ₃, α₃, n₃, ∈₃, T₃ are the conductivity, absorption coefficient, refractive index, dielectric constant, and thickness of TCO 1; n₄, ∈₄, T₄, r₃₃ are the refractive index, dielectric constant, thickness and EO coefficient of EO material; σ₅, α₅, T₅ are the conductivity, absorption coefficient, and thickness of metal contact 2; σ₆, α₆, n₆, ∈₆, T₆ are the conductivity, absorption coefficient, refractive index, dielectric constant, and thickness of TCO 2; n₇, ∈₇, T₇ are the conductivity, absorption coefficient, refractive index, dielectric constant, and thickness of Cladding 2; and n₈, ∈₈, T₈ are the refractive index, dielectric constant, and thickness of substrate.

FIG. 8 is a schematic diagram of an EO modulator structure using a side-conduction design with a 1^{st}/top electrode on the left and a 2^{nd}/bottom electrode covering the bottom, in accordance with this invention:

σ₁, α₁, W₁, T₁ are the conductivity, absorption coefficient, width and thickness of metal contact 1; n₂, ∈₂, T₂ are the conductivity, absorption coefficient, refractive index, dielectric constant, and thickness of Cladding 1; σ₃, α₃, n₃, ∈₃, T₃ are the conductivity, absorption coefficient, refractive index, dielectric constant, and thickness of TCO 1; n₄, ∈₄, T₄, r₃₃ are the refractive index, dielectric constant, thickness and EO coefficient of EO material; σ₅, α₅, T₅ are the conductivity, absorption coefficient, and thickness of metal contact 2; σ₆, α₆, n₆, ∈₆, T₆ are the conductivity, absorption coefficient, refractive index, dielectric constant, and thickness of TCO 2; n₇, ∈₇, T₇ are the conductivity, absorption coefficient, refractive index, dielectric constant, and thickness of Cladding 2; and n₈, ∈₈, T₈ are the refractive index, dielectric constant, and thickness of substrate.

FIGS. 9A and B: (A) illustrates an example of an impedance matching device structure, with non-limiting dimensions provided only for purpose of illustration; and BCB represents B-stage bisbenzocyclobutene; and (B) shows impedance matching simulation results.

FIG. 10 illustrates schematically an example of a fabrication process used in conjunction with an exemplary modulator structure of this invention.

FIG. 11. Structures of TC modulators with (a) vertical and (b) side conduction configuration, are shown further electrically conducted to two metal electrodes that form RF traveling-wave electrodes for higher frequency of operation.

FIG. 12. A diagram of an equivalent circuit for a traveling-wave EO modulator, in accordance with this invention.

FIG. 13. Graphic representations showing dependence of (A) RF speed, (B) modulator impendence and (C) modulation bandwidth on conductivity of TCO.

FIG. 14. A graphic representation of the modulation response of a TCO modulator. Trace 1 is the applied voltage signal. Trace 2 is the optical intensity signal at the output of the modulator.

### DETAILED DESCRIPTION OF THE PREFERRED EMBODIMENTS

For purposes of comparison, a prior art organic EO modulator is shown in FIG. 1. The waveguide core layer can be EO polymer, such as poled polymer or self-assembled superlattice thin film, or another EO material of the sort discussed herein. The core layer thickness is typically 1-3 μm. The top and lower waveguide cladding layers are non-EO polymer, which are typically ˜3-4 μm thick. The refractive index of the waveguide core layer is higher than that of the cladding layers in order to achieve waveguiding in the vertical direction. In the lateral direction, waveguiding is formed by a ridge structure (formed by etching down only part of the top cladding layer thickness) or a channel waveguide structure (formed by etching down to the core part. The top and lower cladding are not only for waveguiding, but also provide buffer layers between the metal and waveguiding layer to reduce metal optical loss. A thick cladding layer will increase the operating voltage due to the decrease in the electrical field strength across the active EO layer, which is proportional to the applied voltage and inversely proportional to the distance between the electrodes. The net result is a reduced effective voltage across the EO material and a necessarily high switching voltage for the modulator. Construction of a prior art device is summarized, below, in Table 1.

TABLE 1
Layer structure of a conventional EO modulator

| Layers | Material | Thickness (μm) |
|---|---|---|
| Top electrode | Metal | — |
| Top cladding | UV -curable polymer | 2.9 |
| EO material | CLD-1/PMMA | 1.4 |
| Bottom cladding | polyurethane | 3.2 |
| Bottom electrode | Metal | — |

In contrast, a TC component, in accordance with this invention, will create an electrical field that is directly applied to the active waveguiding core layer and hence reduce the required operating voltage. The use of transparent conducting films directly in contact with EO material can be used to impose a strong electric field across the EO active layer. One embodiment, as shown in FIG. 2, illustrates an exemplary waveguide plus TC electrode structure. Compared to conventional EO modulator structure with normal cladding and metal electrodes as shown in FIG. 1, this novel EO modulator structure with TC cladding substantially increases the imposed electric field, and provides a stronger electric field across the EO active layer. (See, also, example 5 for further prior art comparisons.)

With reference to FIGS. 2-9, two main parameters should be considered for this type of EO modulator. One is Vπ, the applied voltage to induce a π phase shift, (Eq. 1). Generally, in light of this invention, The smaller Vπ the better. Another is the modulation bandwidth, f, the frequency response of the device given by Eq. 2, but not applicable for traveling waves. The bandwidth, optimally, should be as great as possible.

$$\begin{matrix}{V}_{π} = \frac{λ G}{2 {n}^{3} Γ {r}_{33} L} & ( 1 ) \\ f = \frac{1}{2 π RC} & ( 2 )\end{matrix}$$

Here, λ is the operating wavelength, G is the gap between hot electrode and ground electrode, n is the refractive index of the waveguiding material, F is the percentage of overlap between the optical field and the electric field, r₃₃ is the EO coefficient of the active material, L is the waveguide length that exhibits the EO effect, R is the resistance of the device, and C is the capacitance of the device. Using a TC material to replace top and bottom cladding, G (gap between hot electrode and ground electrode) can be 5-10× smaller, which means a lower Vπ. The device modulation bandwidth can also be much larger because the conductivity of the TCO is also large (very small resistance, R). For a modulator based on an EO material, performance is directly related to the waveguide optical properties and dimensions, electrode configuration (thickness, separation, length), and the cladding material properties and thickness. Due to the complex interdependencies, detailed analyses are needed to define those parameters that simultaneously provide a high bandwidth-to-voltage ratio and impedance near 50Ω.

From Eq. (1), a lower switching voltage can be achieved by either reducing the effective distance between electrodes, increasing the EO coefficient, or increasing the device length. For a given EO material, the device length and electrode distance are the only parameters that can be optimized to achieve low switching voltage. However, there are physical limits. For example, the device length is limited by the intrinsic optical propagation loss of the modulator waveguide. The modulator electrode distance is also thought to be limited and cannot be arbitrary small because of the high optical absorption loss that will occur when the optical wave touch the metal electrodes. An EO modulator of the prior art has cladding layers with a certain minimal thickness to avoid the lightwave touching the top and bottom metal electrodes. The voltage drop across the cladding layers will decrease the actual voltage applied to the active EO layer.

As shown herein, this problem can be alleviated and the effective electrode distance can be made much smaller with the use of optically transparent but electrically conductive materials or transparent conducting materials as cladding materials, resulting in substantial reduction in the modulator switching voltage. Furthermore, a reasonably high modulation speed (e.g., >20 GHz) can be achieved with appropriately engineered transparent conducting materials. As discussed above, one class of transparent conducting materials that can achieve the required properties is the transparent conducting oxides (TCOs). Compared with conventional metal electrodes, TCO electrodes have the advantages of low optical loss and adjustable conductivity. In such new structures, a nonlinear EO material—whether poled or acentric and whether based on organic or inorganic materials—can be directly sandwiched between conductive TCO electrodes without a voltage drop on the top and bottom cladding, which greatly increases the electric field applied to the nonlinear EO materials. As a result, the switching voltage can be reduced substantially. Even so, the side conduction geometries of this invention can tolerate a substantially higher TCO loss coefficient α and a higher refractive index. As demonstrated below, such developments can be used to enhance the benefits available through use of the TC/TCO materials.

To meet the requirements for use in a polymer modulator, a TC film should be transparent and have acceptably low propagation losses at working wavelength (such as about 1.55 μm). The properties of TC (and TCO) materials are determined by their optical transparencies and electrical conductivities. A commonly known TCO is Indium Tin Oxide (ITO) having electrical conductivities of 2.5-5×10³Ω⁻¹ cm⁻¹, which is more than adequate for most modulator applications (see below), but the absorption at 1.55 μm is unacceptably high for some but not all applications. Various known TCOs, including doped ITOs can be prepared, as would be understood in the art, to meet the TC materials requirements for the modulator structures of this invention, as shown below. Other non-oxide TCs can also meet the general structural and materials considerations of the present invention. The materials and structural specifications here are thus not restricted to any specific TCO materials, used or inferred herein, and are generally applicable to other TC materials as is known to those skilled in the art.

As shown in FIG. 2, top and bottom TC layers provide both optical cladding and electric conducting function. With such a structure, the TC can, optimally, have a lower refractive index than the core polymer layer.

In certain embodiments, the thickness of core layer T₃ is less than λ/2(n_{core}²−n_{clad}²)^{1/2} in order to achieve a single mode waveguide. λ is the working wavelength. The factor λ/2(n_{core}²−n_{clad}²)^{1/2} often appears in waveguide calculation as the characteristic length Lc=λ/2(n_{core}²−n_{clad}²)^{1/2}. Consider λ=1500 nm for numerical example. n_{core} is refractive index of waveguide core. n_{clad} is refractive index of cladding, n_{clad} can be n₂ or n₄. For a certain EO material with certain r₃₃, with a target Vπ, the waveguide length L can be calculated from Eq(1).

With this thickness of core layer T₃, the capacitance can be estimated via C=ε₃ε₀W₁L/T₃, where ∈₃ is the dielectric constant of EO material, so is dielectric constant in vacuum (which is 8.85 pF/m), W₁ is waveguide width, and L is waveguide length. With this capacitance and a target bandwidth, then the R required of a TC electrode can be calculated by Eq(2).

The minimum thickness T₂, T₄ of the TC layer is determined by metal loss from top & bottom metal. For a given waveguide length L, α(metal)×L<0.5. T₂, T₄ should typically be >Lc=λ/(n_{core}²−n_{clad}²)/2, because the field in the cladding for a single-mode waveguide typically decays approximately as E˜Exp(−y/Lc), where y is the distance from the core-cladding interface. Hence, the amount of energy at the metal will decay to En-Eˆ2˜Exp(−2 y/Lc). For a given L, α(metal)L˜(L/λ)×(1−En). Requiring α(metal) L<0.5 then gives (L/λ)×(1−En)<0.5, which can be used to determine y, and y will then give the required thickness for T₂ or T₄ (i.e. T₂ or T₄>y). Where, in a worse case, the modulator is one wavelength long, L˜λ, then approximately T₂ or T₄>Lc. For modulators that have L˜1000λ, T₂ or T₄ are typically 3× to 4× Lc (exponential decay factor gives about (1/1000) lower energy at the metal when T₂ or T₄ are 3× Lc compared to when T₂ or T₄ are Lc). With required resistance R and thickness of T₂, T₄, the required TC electric conductivity a can be deduced by resistance R=(T₂+T₄)/(σW₃L). The resistance R is related to the required frequency response bandwidth given by the relationship 1/(RC). If the waveguide length L is known by targeting VT, then the required TC absorption coefficient α can be determined by setting αLΓ_{tc}<1 dB, where Γ_{tc} is the overlapping factor of TC over the optical mode. For a certain EO material with certain r₃₃, with a target Vπ and bandwidth, the electric conductivity σ and absorption coefficient α, or ratio thereof σ/α, can be determined for a particular TC cladding material.

Accordingly, as the electro-optic coefficient for an EO material is known or can be readily ascertained, given the mathematical and functional relationships described above, a TC/TCO component material can be chosen having the conductivity and absorption coefficients providing the applied voltage and bandwidth parameters desired for modulator performance. Such properties and physical characteristics of transparent conducting and transparent conducting oxide materials are known in the art or can be readily determined using known experimental techniques. For instance, various TCO materials of the type useful in context of the present invention (e.g., various ZITO and GITO materials) can be prepared, isolated and/or characterized, then utilized, as described in co-pending application Ser. No. 10/228,521 filed Aug. 27, 2002, together with the technical publications cited therein, such application incorporated herein by reference in its entirety. Conversely, given the conductivity and absorption coefficients for a known TC/TCO cladding/electrode material, a modulator device of the type described herein can be designed and constructed, in conjunction with a particular EO material, to target a desired applied voltage and/or bandwidth. Regardless of a particular EO material, modulator design and component configuration, using TC/TCO materials of the sort described or incorporated herein, will be understood by those skilled in the art made aware of this invention.

### EXAMPLES OF THE INVENTION

The following non-limiting examples and data illustrate various aspects and features relating to the modulator devices and components of the present invention, including the assembly of device structures comprising TC/TCO components as described herein. In comparison with the prior art, the present devices and component structures provide results and data which are surprising, unexpected and contrary thereto. While the utility of this invention is illustrated through the use of several TC/TCO materials/components/layers which can be used therewith, it will be understood by those skilled in the art that comparable results are obtainable with various TC/TCO materials/components/layers, consistent with the mathematical and functional relationships described herein, as are commensurate with the scope of this invention and as would be understood by those skilled in the art having an awareness thereof.

As is well known to those skilled in the art, there are a large number of structures in which a channel optical waveguide can be formed. While the utility of this invention is illustrated through the use of a few exemplary waveguiding structure or single-mode nature waveguiding embodiments they are not meant to restrict the scope of the invention. Any such waveguide can be of a variety of waveguiding structures, single mode or multi mode, with strong or weak optical mode confinement, known to those skilled in the art, providing it guides optical beam energy from one location to another location. As is well known to those skilled in the art, an electro-optic material can form part of or the entire waveguide core or cladding layers or both the core and cladding layers, providing the optical beam energy is finite in the electro-optic material and providing the applied electric field from the TC components reaches the electro-optic material.

### Example 1

For a device structure of such embodiments, the waveguide core layer can be any EO material, such as a poled polymer, self-assembled polymer, LiNbO₃, BaTiO₃, a semiconductor (e.g., GaAs, AlAs, AlGaAs, InP, InGaAs, InGaAsP) or others. PEPCOOH (e.g., a self-assembled polymer; that is, Pyridine-Ethene-Pyrrole-Carboxylic Acid) is used as an example (refractive index n=1.9 at 1.55 μm wavelength). The TC cladding can be any known TC or TCO, such as but not limited to the polymeric materials described herein, as well as ZnO, ZIO, GIO, GITO, ZITO, ITO, CdO or others. Here, ZITO can be used for purposes of example (refractive index n=1.7 at 1.55 μm wavelength). For a device structure, the ridge etching can stop anywhere from the top TCO to the bottom metal, which will give a different mode size of waveguide, single mode or multi mode. Three examples are presented: a 1 st example with etching to the bottom TCO after the EO material, a 2nd example with etching to the bottom metal, and a 3rd example with partial etching half way through the top TCO, as described below.

### Example 1a

1st Example with Etching to Bottom of TCO after EO Material

With reference to the device structure shown in FIG. 2, a TCO thickness is 2 μm (e.g., thick enough to reduce metal loss αL<0.3d) and core layer is 1 μm; waveguide width is 2 μm. As shown in FIG. 3, simulation results clearly show good optical confinement and much stronger electric field (FIG. 3B) cross the EO material compared to a conventional structure (FIG. 3C).

A planar structure as the bottom TCO instead of a ridge structure will give a smaller resistance due to the larger area, ˜2× different (R top=2.19R bottom for this example). The top and bottom TCO can be single layer or multi-layer with the same or different electric conductivity.

To illustrate a single layer TC electrode, a waveguide core layer is PEPCOOH with an EO coefficient r₃₃=120 pm/V and a refractive index n=1.9. The cladding layer is ZITO with a refractive index n=1.7. With three refractive indices, the core thickness and cladding thickness can be determined as shown in the previous discussion: core thickness here is 1 μm and cladding thickness is 2 μm. For a target Vπ=0.5V, the waveguiding sample length is 0.25 cm by using Eq(1). (With a conventional structure, V_{π} will be 2.5-5 V because a thicker non-conductive cladding creates an electrode gap 5-10 times wider.) Depending on desired frequency response, with a 0.25 cm sample length, the absorption coefficient α of ZITO in order to keep αLΓ_{tc}<1 dB (Γ_{tc}=0.2 for this device structure)), should be about 4.5 cm⁻¹.

For a fixed device structure, the electric conductivity of ZITO can be deduced from the target bandwidth by using Eq(2), with consideration of the capacitance and resistance relationships discussed above. If a target bandwidth is 20 GHz, the electric conductivity of ZITO is 0.2 s/cm. Different target bandwidths require different TCO electric conductivity. Table 2 shows a summary of optimal TCO parameters at different frequency responses targeting V_{π}=0.5V.

Summary of TCO parameters at different frequency responses (20 GHz, 40 GHz, 100 GHz), targeting V_{π}=0.5V with r₃₃=120 pm/V.

TABLE 2

| | Target Bandwidth | | |
|---|---|---|---|
| | 20 GHz | 40 GHz | 100 GHz |
| Conductivity σ (s/cm) | >0.2 | >0.4 | >1 |
| Absorption α (cm⁻¹) | <4.5 | <4.5 | <4.5 |

With current ZITO parameters of: absorption a ˜900 cm⁻¹, the conductivity σ˜2000 S/cm. If TCO absorption can be reduced from 900 cm⁻¹ to 4.5 cm⁻¹, conductivity will be 10 S/cm, which is enough for the requirement for 100 GHz operation, with V_{π}=0.5V if only the RC limit is considered.

With a vertical-conduction structure, another advantage is that multilayer TC electrodes can be used. The layers close to the core can have a lower conductivity and lower absorption, while the layers close to metal can have larger conductivity and larger absorption. For a multilayer structure, the layers can be any type of TC with any conductivity and thickness. Optical loss is low and frequency response is high.

Consider the simplest case of a double-layer TC electrode: a 1st layer is 0.6 μm ZITO (n=1.7), and a 2nd layer is 1.4 μm ZITO (n=1.7). The core layer is PEPCOOH with r₃₃=120 pm/V, n=1.9. Based on a calculation analogous for a single TC electrode, a waveguide length=0.25 cm, for a target V_{π}=0.5V, which can be used to deduce absorption and conductivity requirements for the TC electrode. The only difference is that the layer close to core can have a lower conductivity and lower absorption, while the layer close to metal can have larger conductivity and larger absorption. Table 3 shows a summary of TC parameters at different frequency responses for a target V_{π}=0.5V with a double layer TC structure.

Summary of TC parameters at different frequency responses at targeting V_{π}=0.5V with a double layer TC structure.

TABLE 3

| | | Targeting Bandwidth | | |
|---|---|---|---|---|
| | | 20 GHz | 40 GHz | 100 GHz |
| 1st Layer TCO | σ (S/cm) | >0.06 | >0.12 | >0.3 |
| 0.6 μm thickness | α (cm⁻¹) | <3 | <3 | <3 |
| 2nd layer TCO | σ (S/cm) | >0.6 | >1.2 | >3.0 |
| 1.4 μm thickness | α (cm⁻¹) | <30 | <30 | <30 |

For certain applications, if the ZITO absorption can be reduced from 900 cm⁻¹ to 3 cm⁻¹, the conductivity will be 6.7 S/cm, enough for 100 GHz operation with V_{π}=0.5V if only RC limit is considered.

As shown in the modeling results above, use of transparent conducting oxide cladding layers can reduce the driving voltage of an EO modulator by a factor of −5-10×.

### Example 1b

2nd Example with Etching to Bottom Metal after TCO

Another device structure is shown in FIG. 4. With this structure, optical confinement is stronger than that available using the structure of Example 1a. The waveguide can be narrower for nano-scale application. TC parameter calculations for a target V_{π} and frequency responses are based on the principles discussed in Example 1a.

### Example 1c

3rd Example with Partial Etching to Top TCO

Another device structure is shown in FIG. 5. With this structure, optical confinement is weaker, as compared to the structures of Examples 1a and 1b. Mode size of a waveguide can be larger, for better fiber coupling. Also, shallow etching eases fabrication. TC parameter calculations for a target V_{π} and frequency responses are as discussed above.

### Example 2

Modulator with Current-Flow-From-Side Structure

Another embodiment of this invention provides side electrical conduction. With this device structure, a polymer core layer can have lower refractive index than a TC/TCO component. An additional cladding layer with lower refractive index on both top and bottom provides waveguiding in a vertical direction (FIG. 6). Lateral guiding is formed by a ridge structure on the top cladding. A very thin layer TC with a higher refractive index will not impact guiding by the waveguide core.

For this structure, the waveguide core layer can be any EO material, such as a poled polymer, self-assembled polymer, LiNbO₃, BaTiO₃, semiconductor (e.g., GaAs, AlAs, AlGaAs, InP, InGaAs, InGaAsP) or others. Here a self-assembled superlattice (SAS), as described above, was used as an example (refractive index n=1.6). Cladding can be of any known TC or TCO material, such as but not limited to ZnO, ZIO, GIO, GITO, ZITO, ITO, CdO or others. Here, ZITO was used as an example (refractive index n=1.7). Additional top and lower cladding can be any material with a lower refractive index: for instance, Cytop (n=1.34) as described above, can be used for a top cladding with SiO₂ (n=1.46) for a lower cladding. (See, e.g., the incorporated '685 patent.)

For such a device structure, the top and bottom electrode can be any shape or any configuration. Three examples are presented: a 1st example with a 1st/top electrode on the left and a 2nd/bottom electrode on right, a 2nd example with a 1 st/top electrode on left and a 2nd/bottom electrode on left, and a 3rd example with a 1st/top electrode on the left and a 2nd/bottom electrode covering the whole bottom.

The TC conductivity and absorption parameter calculations are much the same as with current-flow-from-top. Capacitance can be calculated using commercially-available Finite element method software known in the art. Core layer thickness and other waveguide dimension can be obtained using available mode solver or finite element method software, also known in the art and commercially available.

The thickness of core layer T₄ is, optimally, less than approximately Lc=λ/2(n_{core}²−n_{clad}²) λ in order to keep single mode waveguiding. (Mode solver software can provide an accurate waveguide dimension, accounting for a complex TC multilayer structure.) λ is the working wavelength and can be from about 200 nm to about 1700 nm. 1500 nm can be used as an example. n_{core} is refractive index of waveguide core. n_{clad} is refractive index of cladding.

For a certain given TC/TCO material with certain r₃₃, if a target V_{π} is known, then the waveguide length L can be determined from Eq(1). With this thickness T₄, the capacitance can be estimated by C=∈₃∈₀W₁L/T₃ (or more accurate result by finite element method). ∈₄ is the dielectric constant of EO material. ∈₀ is dielectric constant in vacuum, which is 8.85 pF/m. W₁ is overlapping width of the 2 TC electrodes. L₄ is waveguide length. More accurate capacitance can be calculated by Finite element method. With this capacitance and a target bandwidth, then the required R of a TC electrode can be calculated by Eq(4).

The thickness T₂, T₇ of the cladding layer should be thick enough so that substrate loss will be low. But thickness is not as critical as with a top-bottom structure because of less effect on the capacitance value. If the waveguide length L is known for a certain target V_{π}, then the required TC absorption coefficient α can be determined by setting αL.Γ_{tc}<0.3 dB. Γ_{tc} is overlapping factor of TC over optical mode, that can be obtained from any type of mode solver software known in the art. As discussed above, for a given EO polymer with certain r₃₃, for a target V, and bandwidth, the electric conductivity σ and absorption coefficient α for a useful TC cladding material can be ascertained.

### Example 2a

Example 1 with a 1 st/Top Electrode on the Left and a 2nd/Bottom Electrode on Right

The metal electrodes (Au as an example) are placed on the side instead of the top of the TC to reduce metal loss (FIGS. 6A and 6B). A metal electrode is placed on the top left. Two cases are illustrated: (a) A second metal electrode is placed on the bottom right as illustrated in FIG. 6A; (b) A second metal electrode is placed on the top right as illustrated in FIG. 6B. The case of second electrode at the bottom gives a vertical field in the EO material while the case of second electrode at the top gives a horizontal field in the EO material. The horizontally applied field in the EO materials is particularly conducive for the case of modulators based on certain electro-optic material with high EO coefficient for horizontally applied field. Examples are certain EO crystal materials made of LiNbO₃, BaTiO₃, or semiconductors. The two side electrodes are placed to minimize overlapping of the two electrodes, and gives smaller capacitance for high speed modulation. The main resistance comes from the bridge part of the TC, as it is narrower. Therefore, this component can be made thicker to reduce resistance.

The device structure can be any shape depending on the application. By using mode solver and finite element method software, a device structure is provided as follows for a target V_{π}=0.5V. In the case of the bottom side electrode of FIG. 6A, the core layer SAS(n=1.6, r₃₃=120 pm/V) is 1 μm in thickness for single mode waveguide. A top cladding of Cytop(n=1.34) is 2.0 μm in thickness and 3 μm in width. A bottom cladding of SiO2 is 2.0 μm in thickness. The overlapping of 2 TC electrodes is 5 μm for reducing capacitance. The gap between metal and ridge waveguide is 5 μm to keep low absorption from metal. TC electrode thickness is 0.1 μm in the waveguide part and 0.3 μm in non-waveguide part, for managing the resistance and TCO absorption as well. With the example structure above, a sample length=0.25 cm can be obtained for a V_{π}=0.5V. Depending on application and desired frequency response, with a 0.25 cm sample length, the absorption coefficient α of ZITO in order to keep αLΓ_{tc}<1 dB, should be about 11 cm⁻¹.

With a fixed device structure, the required electric conductivity of ZITO can be deduced for a target bandwidth by using Eq(2), with consideration of the capacitance and resistance relationships discussed above. If a target bandwidth is 20 GHz, electric conductivity of a ZITO component should be >7.5 s/cm. Different target bandwidths will require different TCO electric conductivities. Table 4 shows a summary of TCO parameters at different frequency responses targeting V_{π}=0.5V.

Summary of TCO parameters at different frequency responses, targeting V_{π}=0.5V with current flow from side structure.

TABLE 4

| | Targeting Bandwidth | | |
|---|---|---|---|
| | 20 GHz | 40 GHz | 100 GHz |
| Conductivity σ (s/cm) | >7.5 | >15.0 | >37.5 |
| Absorption α (cm⁻¹) | <11 | <11 | <11 |

For ZITO (Zn—In—Sn—O), materials, parameters are: absorption α˜900 cm⁻¹, conductivity σ˜2000 S/cm. If TCO absorption can be reduced from 900 cm⁻¹ to 11 cm⁻¹, the conductivity is 24 S/cm. Such a device can be capable of ˜60 GHz operation with V_{π}=0.5V if only the RC limit is considered.

### Example 2b

Example 2 with a 1 st/Top Electrode on Left and a 2nd/Bottom Electrode on Left

The metal electrodes (Au as an example) are placed on the side instead of the top of the TCO, to reduce metal loss (FIG. 7). A bottom metal placed on the left (same side as top electrode) enhances RF transmission performance, for high speed modulation. The TC parameter calculations for a target V, and representative frequency responses are based on the principles discussed with Example 2b.

### Example 2c

Example 3 with a 1st/Top Electrode on Left and a 2nd/Bottom Electrode Covering the Whole Bottom

The metal electrodes (Au as an example) are placed on the side instead of the top of the TCO to reduce metal loss (FIG. 8). The bottom electrode is placed on the whole bottom, a simpler process since no TCO etching step is needed. Also RF shielding will be better for this structure. The TC calculation for a target V_{π} and frequency response are based on the same principles as discussed above.

### Example 3

High-Speed Design (Impedance, RC, Traveling Wave)

For an EO modulator design, V_{π} is just one of the parameters to consider. Another consideration in a high-speed design or RF design is impedance. The TC materials are further electrically conducted to two metal electrodes, which can form an RF transmission line, with a certain RF transmission line impedance for an electric field pattern traveling down the RF transmission line as is well known to those skilled in the art, as the RF traveling-wave electrodes for the modulators. Such traveling-wave electrodes are used to further increase the modulation frequency bandwidth of the modulator. To achieve good modulation frequency characteristics and efficient RF power transfer from the electronic driver to the modulator, impedance matching can be very important. Usually the impedance of the transmission line needs to be ˜50Ω to match the RF source and RF cable. Impedance of an EO modulator is related to metal structure (geometry) and dielectric material in between. Anything that can change capacitance will change impedance.

There are various ways to achieve a ˜50Ω impedance. With simulation via finite element method, a device structure and electric field are shown in FIG. 9. For this device structure, the gap between top and bottom electrode is very small so the capacitance will be very large. As a result, the impedance would typically be small (<50 Ohms). In order to achieve 50 Ohms impedance, the device structure is optimized, by increasing electrode gap, reducing electrode width, etc. The optimized device structure (including all the dimensions and material) is shown in FIG. 9A. The electric field is shown in FIG. 9B. With this structure, impedance is ˜50 Ohms.

### Example 4

There are various ways to fabricate the modulator structures described above. FIG. 10 shows an exemplary approach. The modulator is made by several process steps, which begin with metal deposition. TCO is deposited on the metal by sputtering such as ion-assisted deposition, after which the polymer active layer is grown on the top of TCO. Then, another TCO layer is deposited on it. Finally, another metal layer is deposit on the top. The ridge structure is formed by etching, as known in the art. More specifically, the following steps can be taken to fabricate various modular structures of this invention:

Step 1: Deposit metal contact layer 2 on substrate. The substrate can be semiconductor wafer such as Si, GaAs, or InP. The thickness of substrate T6 is around 200-500 μm and metal thickness T5 is about 100 nm.

Step 2: Deposit TCO2 and EO material and TCO1 sequentially. The minimum thickness of TCO is determined by metal loss. TCO can be deposited by sputtering. EO materials are synthesized directly on the TCO surface via spin coating or a self-assembly process. EO materials are poled polymers or self-assembled synthesized EO materials.

Step 3: Spin coat or deposit etch mask on top of the multiplayer structure. The etch mask pattern can be generated using photosensitive materials or transferred from photosensitive materials such as photoresist. The waveguide pattern will be formed by subsequent wet or dry etching.

Step 4: The patterned wafer will be planarized using dielectric films. Etch mask of previous step will be removed and metal contact 1 will be deposited. One example of a dielectric material is Cytop.

Step 5: Electrical contact area to metal contact 2 will be opened by etching away some of the planarization materials. Etching mask will be photosensitive materials such as photoresist.

### Example 5

Another layer structure of this invention is shown in Table 5. Assuming the same dielectric constant of the cladding and EO materials of a prior art device, such TCO modulator can produce a 4-6 times stronger electric field, which in turn can provide a 4-6 times lower switching voltage, as compared to the prior art structure (NOA74 and AJL8 are designations for commercially available cladding and EO materials respectively).

TABLE 5
Layer structure of a TCO EO modulator.

| Layers | Material | Index | Thickness (μm) |
|---|---|---|---|
| Top cladding | NOA74 | 1.55 | 0.8 |
| Top electrode | TCO(In₂O₃) | 1.7-2 | 0.05 |
| EO material | AJL8 | 1.56 | 1.5 |
| Bottom electrode | TCO(ZnO) | 1.7-2 | 0.05 |
| Bottom cladding | SiO₂ | 1.48 | 2.5 |
| Substrate | GaAs | 3.4 | — |

A straightforward structure for a TCO based EO modulator is a vertical conduction geometry that replaces all cladding materials with TCOs, as shown in FIG. 11A. However, in this structure the TCO cladding materials should have a lower refractive index than the waveguide core material and the optical loss must be low enough for practical modulator application. The application of current TCOs as electrodes in waveguide structure is restricted by the high optical loss and high refractive index of the material. Current TCOs usually have a higher refractive index (1.7-2.0) than most organic materials (˜1.5) at a wavelength of 1.3-1.5 μm. Another available TCO modulator structure is via a side conduction geometry in which a thin but highly conductive layers of TCO bring the voltage to the top and bottom part of the active materials from two metallic electrodes on the side, as shown in FIG. 11B. In this geometry, as the TCO layer can be much thinner and will have a low overlapping factor with the optical field, it can have higher optical absorption coefficient and yet still keep a low waveguide optical loss. Another advantage of the side conduction geometry is that the TCO materials do not need to have lower refractive index than the waveguide core, as separate materials can be used for the top and bottom cladding layers above and below the thin TCO layers, respectively. Such components can be of the typical cladding materials with low refractive indices.

### Example 6

RF transmission lines require the TCO electrodes to have low resistance while modulator waveguide requires the TCO materials to have low optical loss. Low optical loss and high conductivity cannot be achieved simultaneously. For materials having high conductivity, high carrier concentration will result in higher free carrier absorption. Hence there is a minimum requirement in terms of conductivity and optical loss to obtain specific modulation speeds. It is possible to estimate the minimum requirements of TCO conductivity and optical loss by simulating representative side conducting modulator structure. As discussed above, an important parameter is the σ/α ratio. It is, in general, desirable to achieve as high a σ/α ratio as possible for the TCO materials to optimize its application to high-speed and low voltage EO modulators.

For purposes of illustration, use the modulator structure summarized in Table 5 with the side conduction configuration. The thickness of the TCO layer on both sides of the waveguide core (FIG. 11B) is taken to be 50 nm. The optical energy confined in the TCO layers is ˜1% and 80% of light is confined in the EO waveguide core layer. Assuming an EO material with EO coefficient of 60 pm/V, a device length of 0.5 cm will yield a 7 phase-shift switching voltage of 1V with a push-pull Mach-Zehnder configuration. The bulk optical loss of the TCO layers must be <45/cm with <20% waveguide propagation for 0.5 cm propagation length. With a high EO coefficient material, the modulator device can be shorter and yet still achieve same switching voltage, so the optical loss limitation can be reduced, providing use of TCO materials with low optical loss and good conductivity.

### Example 7

The modeling of this example provides the basis for an RF transmission line design for the TCO modulator and illustrates the TCO conductivity needed to achieve operating speed above 20 GHz.

FIG. 12 shows, by diagram, the equivalent circuit of traveling-wave EO modulator with a TCO material as electrode. The TCO layer was modeled as a series resistance Rₛ. The series resistance per unit length of the TCO layer can be expressed as: Rₛ=L_{TCO}/((σ_{TCO} t_{TCO}), where L_{TCO} is the distance between the waveguide and the metal transmission line, σ_{TCO} is the TCO material conductivity and t_{TCO} is the thickness of the TCO layer. In FIG. 12, R_{con} is the metal transmission line conduction resistance, Lm is the metal inductance, Cp is the parasitic capacitance, and Cₘ is the capacitance of the modulator. Using the circuit parameters in FIG. 21, all of the relevant microwave properties of a traveling wave TCO EO modulator can be derived from:
Zₘ={square root over ((R_{con}+jωLₘ)/(jωCₚ+1/(Rₛ+1/jωₘ)))}, (3)
γ_{μ=α}_{μ}+jβ_{μ}={square root over ((R_{con}+jωLₘ)jωCₚ+1/(Rₛ+1/jωCₘ)))}, (4)
where, Zₘ is the impedance, γ_{μ} is the microwave propagation constant, α_{μ} is the microwave attenuation and β_{μ}=ω/ν_{μ} is the microwave propagation constant associated with the microwave phase velocity ν_{μ}.
By including multiple microwave reflections inside the modulator, RF voltage can be expressed as:

$${V}_{RF} = \frac{{V}_{0} T exp ( jω t )}{1 - {Γ}_{L} {Γ}_{S} exp ( - 2 {γ}_{μ} L )} [ \begin{matrix}exp ( - {γ}_{μ} x ) + \\ {Γ}_{L} exp ( {γ}_{μ} x - 2 - {γ}_{μ} L )\end{matrix} ] , \qquad ( 5 )$$

where V0 is the input microwave voltage in the source transmission line, Γₛ and Γ_{L} are the microwave reflection coefficients at the source (x=0) and load position (x=L), T=1−Γₛ is the amplitude transmission coefficient at the source port, ω is the microwave frequency. The effective voltage drop along the modulator with electrode length L is:

$${V}_{eff} = \frac{1}{L} {\int }_{0}^{L} \frac{1 / jω {C}_{m}}{{R}_{s} + 1 / jω {C}_{m}} {V}_{RF} ( x , t = {t}_{0} + \frac{x}{{v}_{0}} ) ⅆ x , \qquad ( 6 )$$

where, σ₀ is the group velocity of the optical wave packet in the modulator waveguide.
The optical output of the MZ modulator is:

$${A}_{out} = \frac{\sqrt{2}}{2} ( {A}_{1} {ⅇ}^{{jΦ}_{1}} + {A}_{2} {ⅇ}^{jΦ2} ) , \qquad ( 7 )$$

where A₁ and A₂ represent the optical amplitude in the two arms. (A₁²+A₂²) is the total optical input power. Φ₁ and Φ₂ represent the optical phase delays. The output power is

$${P}_{out} = {\vert {A}_{out} \vert}^{2} = \frac{1}{2} [ {A}_{1}^{2} + {A}_{2}^{2} + 2 {A}_{1} {A}_{2} cos ( {Φ}_{1} - {Φ}_{2} ) ] , \qquad ( 8 )$$

Optical intensity transfer function is defined as:

$${T}_{MZ} = {\vert {A}_{out} \vert}^{2} / [ {A}_{1}^{2} + {A}_{1}^{2} ] = \frac{1}{2} [ 1 + b cos ( {Φ}_{1} - {Φ}_{2} ) ] , \qquad ( 9 )$$

where b=2A₁A₂/(A₁²+A₂²) is the optical imbalance factor between the two arms.
For EO modulator:

$$ΔΦ = {Φ}_{1} - {Φ}_{2} = {Γ}_{optical} Δ n \frac{2 π}{λ} L ,$$

where Γ_{optical} is the optical confinement factor of EO material layer, λ is the optical wavelength, L is the modulation electrode length, Δn is the optical index change in the EO

$$layer , Δ n = \frac{1}{2} {n}_{0}^{3} {r}_{ij} \frac{V}{d} .$$

V/d is the applied electric field to the EO material with refractive index of n₀ and EO coefficient of rᵢⱼ.

TABLE 6
TCO EO modulator simulation parameters.

| Parameters | Value | |
|---|---|---|
| L | 0.5 | cm |
| L_{TCO} | 5 | μm |
| t_{TCO} | 5 | μm |
| Cₘ | 0.1 | pF/mm |
| Cp | 0 | pF/mm |
| R_{con} | 3.5 | Ωmm⁻¹GHz^{-1/2} |
| Lₘ | 0.1-1 | nH/mm |
| Γₛ | 0 | |
| Γₗ | 0 | |

In the simulation, the device length is assumed 0.5 cm, EO coefficient rᵢⱼ=60 pm/V, Γ_{optical}=80%. EO layer thickness is 1.5 μm with index of 1.56. So the static 7 phase-shift switching voltage is 1V with a pull-push configuration. Total thickness t_{TCO} of the TCO layer is assumed 100 nm (50 nm each electrode), and the gap L_{TCO} between waveguide and metal transmission line is 5 μm on each TCO electrodes. The unit length series resistance of TCO layer can be expressed as: Rs=L_{TCO}/(σ_{TCO}t_{TCO}), where σ_{TCO} is the conductivity of TCO layer. The capacitance per unit length of the device is calculated to be 0.1 pF/mm. For the transmission line parameters, take some typical value from a semiconductor modulator. R_{con}˜3.5Ω mm⁻¹ GHz^{-1/2}, Lₘ will fall in the range of 0.1−1nH/mm. For simplicity, assume Cp=0. FIG. 13 shows the dependence of RF speed (A), modulator impendence (B) and modulation bandwidth on conductivity of TCO. With the TCO conductivity larger than 50 S/cm, the TCO modulator can operate above 20 GHz. Accordingly, a figure-of-merit for the TCO material can be 50/45 (S)˜1 S. Higher EO coefficient materials will have even lower figures-of-merit since the device can be made shorter. The above analysis illustrated that for a preferred embodiment of the present invention to achieve 20 GHz frequency response for a modulator based on an exemplary EO material with a EO coefficient of rᵢⱼ=60 pm/V, a TCO figure of merit of ˜1 S is sufficient. Thus, depending on the EO coefficient and frequency response requirements, TCO materials of >0.1 S are typically desirable for GHz frequency response with typical EO coefficients of tens of pm/V or higher.

### Example 8

With reference to example 4, an organic TCO EO modulator can be fabricated to demonstrate the modulation voltage reduction by using TCOs associated electrodes. (See FIG. 11B, with reference to Table 5.) A bottom cladding of 2.5 μm thick SiO₂ was first deposited on a GaAs wafer by plasma-enhanced chemical vapor deposition (PECVD) techniques. The typical growth temperature was −300° C. and the refractive index of SiO₂ was measured to be 1.48. The SiO₂ thickness of 2.5 μm was determined by keeping the substrate coupling loss to be less than 0.1/cm. The bottom electrode material was ZnO grown, using known techniques, by low-pressure MOCVD at 450° C. and has a thickness of 50 nm. The bottom ZnO electrode was patterned using standard photolithography and wet etching techniques. A nonlinear organic EO material representative of those useful herewith (25% in amorphous poly(carbonate) (APC) host) was directly spin coated on bottom ZnO electrode. The thickness of the EO layer was ˜1.5 μm. A poling protective layer of 1.5 μm poly(4-vinylphenol) (PVP) was spin-coated on top of the EO layer before depositing metal electrodes for the poling process. The film was then poled at 140° C. with a poling voltage of 300 V for 5 mins, then cooled down to room temperature while keeping the electric field applied to the sample. After the poling procedure, the top metal electrode was etched away using wet chemical etching and the poling protective layer (PVP layer) was washed away using methanol. Then a 30 nm In₂O₃ top electrode was deposited using the IAD system at room temperature. The top IAD In₂O₃ electrode pattern was defined by a shadow mask. Above the top electrode, a thin cladding layer was spin-coated and UV cured at room temperature. A ridge waveguide structure with a thickness of 0.8 μm and width of 3 μm was next formed using photolithography and RIE O₂ plasma etching. As discussed elsewhere herein, various other TCO materials and acentric, non-poled EO materials can be used with comparable effect in a range of device structures, consistent with broader aspects of this invention.

### Example 9

The switching voltage of a TCO modulator fabricated, as described below, was measured using a single straight waveguide with λ=1.31 μm light from a DFB laser diode coupled into the modulator waveguide using an optical objective lens. Two polarizers with polarization perpendicular to each other and at 45° to the applied field on the modulator were used to analyze the phase change of the TE/TM mode before and after the modulation. An oscilloscope was used to record the applied voltage and output light intensity.

FIG. 14 shows the typical EO response of the TCO modulator. Trace 1 and 2 in FIG. 14 represent the applied voltage signal and response signal of the modulator, respectively. The half-wave voltage V_{π} is measured to be 2.8V for an 8 mm long waveguide. The EO coefficient of the poled polymer was calculated to be about 35 pm/V by using the above device parameters. Using the same poling conditions, the EO coefficient is measured to be 68 pm/V immediately after poling. The reduction of the EO coefficient in the actual sample is likely due to the thermal treatment process after poling.

A figure of merit of EO modulator performance is the voltage and interaction length product V_{π}L. For this non-limiting TCO modulator, V_{π}L=1.1 V·cm is achieved with a non push-pull geometry. This is small considering the EO coefficient of the active material is 35 pm/V. For a conventional structure with a push-pull configuration, the V_{π}L is 2.2 V·cm with a EO coefficient of 58 pm/V. Thus, for the same EO coefficient and push-pull electrode configuration, the TCO modulator has a 6.5 times lower switching voltage. Part of this reduction (˜5×) comes from reducing the electrode separation from 7.5 μm to 1.5 μm. Stronger mode confinement for the TCO modulator due to the use of higher refractive index contrast between the waveguide core and cladding also contributes to its lower switching voltage.

1. An electro-optic modulator device operable at a switching voltage, said device comprising:
a waveguide component comprising a non-linear electro optical material;
opposed electrode components, said waveguide component therebetween; and
a conductive component connecting each said electrode with said waveguide component, each said conductive component providing a transparency sufficient for a frequency response at said switching voltage.

2. The device of claim 1 wherein said conductive component comprises a transparent conducting metal oxide compound.

3. The device of claim 2 wherein said conductive component comprises a plurality of transparent conducting metal oxide layers.

4. The device of claim 1 wherein said electrode components are positioned above and below said waveguide component.

5. The device of claim 4 wherein at least one of said electrode, conductive and waveguide components are configured to affect optical confinement.

6. The device of claim 4 comprising cladding components beside said waveguide and conductive components.

7. The device of claim 1 wherein said electrode components are positioned beside said waveguide component.

8. The device of claim 7 comprising cladding components above and below said waveguide component, and the refractive index of said electro optical material is lower than the refractive index of said conductive component.

9. The device of claim 8 wherein said conductive component comprises a transparent conducting metal oxide compound.

10. An electro-optic modulator device operable at a switching voltage, said device comprising:
a waveguide component comprising a non-linear electro optical material;
opposed electrode components, said waveguide component therebetween; and
a conductive component connecting each said electrode with said waveguide component, each said conductive component comprising a transparent conducting metal oxide compound having a transparency sufficient for a particular frequency response at said switching voltage.

11. The device of claim 10 wherein said conductive component comprises a plurality of transparent conducting metal oxide layers.

12. The device of claim 10 wherein said electrode components are positioned above and below said waveguide component.

13. The device of claim 12 wherein at least one of said electrode, conductive and waveguide components are configured to affect optical confinement.

14. The device of claim 12 comprising cladding components beside said waveguide and conductive components.

15. The device of claim 10 wherein said electrode components are positioned beside said waveguide component.

16. The device of claim 15 comprising cladding components above and below said waveguide component, and the refractive index of said electro optical material is lower than the refractive index of said conductive component.

17. A method of using a transparent conducting metal oxide compound to affect electro-optic modulator device performance, said method comprising:
providing opposed electrode components and a waveguide component therebetween, said waveguide component comprising a non linear electro optical material; and
coupling each said electrode component and said waveguide component with a conductive component, each said conductive component comprising a transparent conducting metal oxide compound optically transparent and electrically conductive sufficient to provide a frequency response at a device switching voltage.

18. The method of claim 17 wherein said electrode components have a positional configuration selected from above and below said waveguide component, and beside said waveguide component, said conductive component dimensioned to provide an electrode separation and an electric field strength across said electro-optical material sufficient for a switching voltage.

19. The method of claim 17 wherein said conductive component comprises an indium oxide compound.

20. The method of claim 19 wherein said compound comprises an additive selected from Zn, Gd, Sn and combinations thereof.

21. The method of claim 20 wherein said electrode components have a positional configuration selected from above and between said waveguide component, and beside said waveguide component, said conductive component dimensioned to provide an electrode separation and electric field strength across said electro-optical material sufficient for a switching voltage.
